(19) United States
(12) Patent Application Publication
(10) Pub. No.: US 2024/0077513 A1
(43) Pub. Date: Mar. 7, 2024

(54) ACCELERATION SENSOR SYSTEM

(71) Applicant: ROHM CO., LTD., Kyoto (JP)

(72) Inventor: Akimasa MARUO, Kyoto (JP)

(21) Appl. No.: 18/456,191

(22) Filed: Aug. 25, 2023

(30) Foreign Application Priority Data
Sep. 2, 2022 (JP) 2022-140231

(51) Int. Cl. G01P 15/125

(52) U.S. Cl. CPC G01P 15/125

(57) ABSTRACT

An acceleration sensor system, includes: an acceleration sensor including an acceleration detection part and an offset detection part; and a processing part configured to process respective outputs of the acceleration detection part and the offset detection part, wherein the acceleration detection part includes a first electrode, a second electrode, and a third electrode provided between the first electrode and the second electrode, wherein one of each of the first and second electrodes and the third electrode is a fixed electrode while the other of each of the first and second electrodes and the third electrode is a movable electrode, wherein the offset detection part includes a fourth electrode, a fifth electrode, and a sixth electrode provided between the fourth electrode and the fifth electrode, and wherein the fourth electrode, the fifth electrode, and the sixth electrode are fixed electrodes.

### CROSS-REFERENCE TO RELATED APPLICATION

This application is based upon and claims the benefit of priority from Japanese Patent Application No. 2022-140231, filed on Sep. 2, 2022, the entire contents of which are incorporated herein by reference.

### TECHNICAL FIELD

The present disclosure relates to an acceleration sensor system.

### BACKGROUND

Acceleration sensors for measuring acceleration acting on an object are widely used to grasp, for example, the posture, motion, and vibration state of the object. In addition, there is a strong demand for miniaturization of acceleration sensors. In order to meet such a demand, so-called MEMS (Micro Electro-Mechanical System) technique is used to reduce the size of acceleration sensors. For example, a capacitive acceleration sensor using a MEMS technique is known in the related art.

### BRIEF DESCRIPTION OF DRAWINGS

The accompanying drawings, which are incorporated in and constitute a part of the specification, illustrate embodiments of the present disclosure.

FIG. 1 is a plan view showing a structural example of an acceleration sensor.

FIG. 2 is a side view showing the structural example of the acceleration sensor.

FIG. 3 is a plan view showing another structural example of the acceleration sensor.

FIG. 4 is a side view showing another structural example of the acceleration sensor.

FIG. 5 is a diagram showing a schematic configuration of an acceleration sensor system according to a first embodiment.

FIG. 6 is a diagram showing a schematic configuration of an acceleration sensor system according to a second embodiment.

FIG. 7 is a diagram showing a schematic configuration of an acceleration sensor system according to a third embodiment.

FIG. 8 is a diagram showing a schematic configuration of an acceleration sensor system according to a fourth embodiment.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

### Structural Example of Acceleration Sensor

A structural example of an acceleration sensor 100 used in each embodiment will be described.

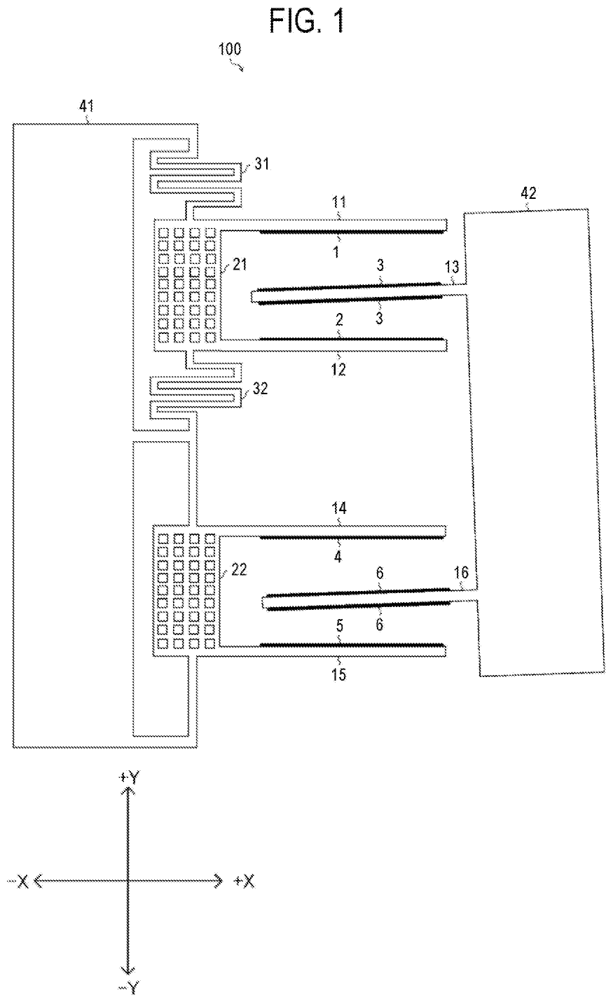

For the sake of convenience of explanation, the +X direction, −X direction, +Y direction, −Y direction, +Z direction, and −Z direction shown in FIGS. 1 to 4 may be used hereinafter. The +X direction is one direction extending along the surface of a flat plate portion 11 in a side view. The +Z direction is a direction extending along the surface of the flat plate portion 11 in a side view and orthogonal to the +X direction. The +Y direction is a direction extending along the thickness of the flat plate portion 11 and orthogonal to the +X direction and the +Y direction.

The −X direction is the direction opposite to the +X direction. The −Y direction is the direction opposite to the +Y direction. The —Z direction is the direction opposite to the +Z direction. The +X direction and the −X direction are collectively referred to as “X-axis direction.” The +Y direction and the −Y direction are collectively referred to as “Y-axis direction.” The +Z direction and the −Z direction are collectively referred to as “Z-axis direction.”

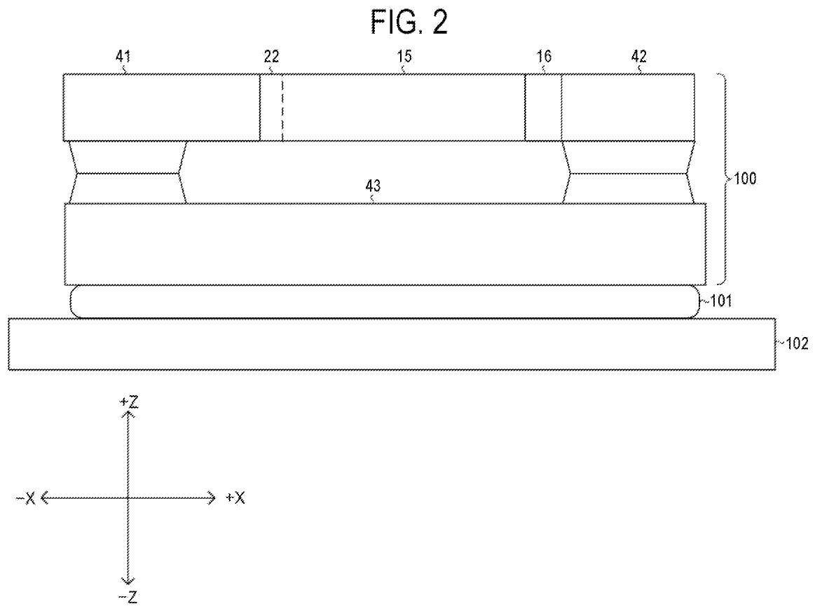

FIG. 1 is a plan view showing a structural example of the acceleration sensor 100. FIG. 2 is a side view showing a structural example of the acceleration sensor 100. FIG. 1 depicts only a portion of the acceleration sensor 100 on the +Z direction side.

The acceleration sensor 100 includes electrodes 1 to 6, flat plate portions 11 to 16, connection portions 21 and 22, elastic structure portions 31 and 32, support portions 41 and 42, and a base portion 43.

A structure including the flat plate portions 11 to 16, the connection portions 21 and 22, the elastic structure portions 31 and 32, the support portions 41 and 42, and the base portion 43 is formed by, for example, finely processing a semiconductor substrate.

The electrodes 1 to 6 are rectangular when viewed from the Y-axis direction. The shape and size of the electrode 1 are the same as the shape and size of each of the electrodes 2 to 6. The shape of the electrodes 1 to 6 may be other than the rectangular shape.

The electrode 1 is arranged on the −Y direction side of the flat plate portion 11. The electrode 2 is arranged on the +Y direction side of the flat plate portion 12. A pair of electrodes 3 are arranged on the +Y direction side and the −Y direction side of the flat plate portion 13, respectively. The flat plate portion 13 is arranged between the flat plate portions 11 and 12 in the Y-axis direction to face each of the flat plate portions 11 and 12.

The flat plate portion 11 and the flat plate portion 12 are connected by the connection portion 21. The support portion 41 supports the flat plate portion 11, the flat plate portion 12, and the connection portion 21 via elastic structure portions 31 and 32. As a result, the electrodes 1 and 2 serve as movable electrodes that move in the Y-axis direction when the acceleration sensor 100 receives acceleration in the Y-axis direction.

The support portion 42 supports the flat plate portion 13 without interposing an elastic structure portion. As a result, the electrode 3 serves as a fixed electrode that does not move in the Y-axis direction even when the acceleration sensor 100 receives acceleration in the Y-axis direction.

The electrode 4 is arranged on the −Y direction side of the flat plate portion 14. The electrode 5 is arranged on the +Y direction side of the flat plate portion 15. A pair of electrodes 6 are arranged on the +Y direction side and the −Y direction side of the flat plate portion 16, respectively. The flat plate portion 16 is arranged between the flat plate portion 14 and the flat plate portion 15 in the Y-axis direction to face each of the flat plate portions 14 and 15.

The flat plate portion 14 and the flat plate portion 15 are connected by the connection portion 22. The support portion 41 supports the flat plate portion 14, the flat plate portion 15, and the connection portion 22 without interposing an elastic structure portion. As a result, the electrodes 4 and 5 serve as fixed electrodes that do not move in the Y-axis direction even when the acceleration sensor 100 receives acceleration in the Y-axis direction.

The support portion 42 supports the flat plate portion 16 without interposing an elastic structure portion. As a result, the electrode 6 serves as a fixed electrode that does not move in the Y-axis direction even when the acceleration sensor 100 receives acceleration in the Y-axis direction.

The base portion 43 supports the support portions 41 and 42.

The acceleration sensor 100 is fixed to a package frame 102 by, for example, an adhesive 101. Since the acceleration sensor 100 and the adhesive 101 have different coefficients of thermal expansion, non-uniform stress is generated in the acceleration sensor 100 due to a temperature change. This non-uniform stress causes strain, and the positions of the electrodes 1 to 3, which are ideally arranged in parallel, are displaced depending on the temperature (see FIG. 1). In addition, the positions of the electrodes 4 to 6 are displaced depending on the temperature, in a similar manner as the positions of the electrodes 1 to 3 (see FIG. 1).

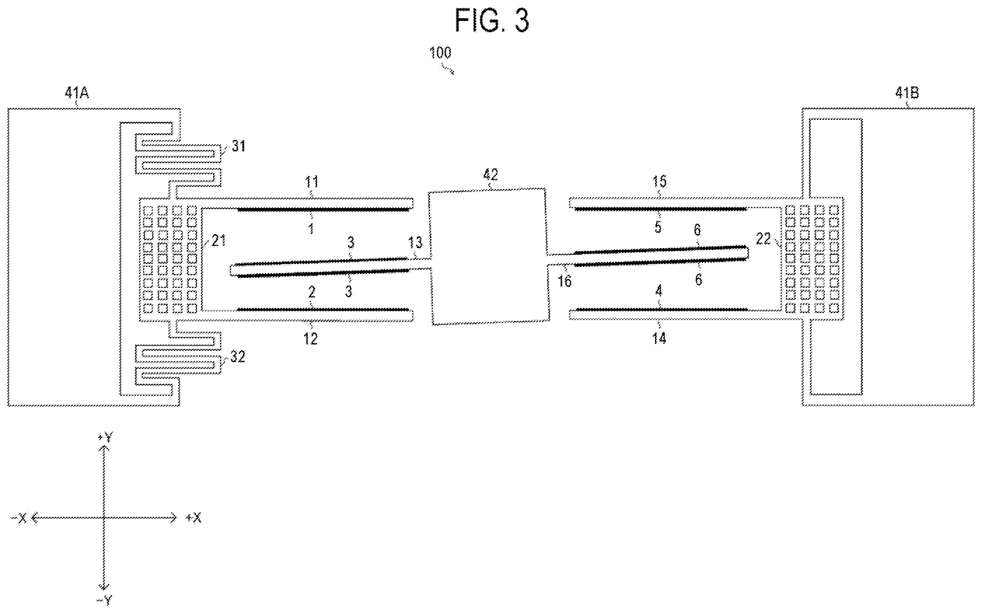

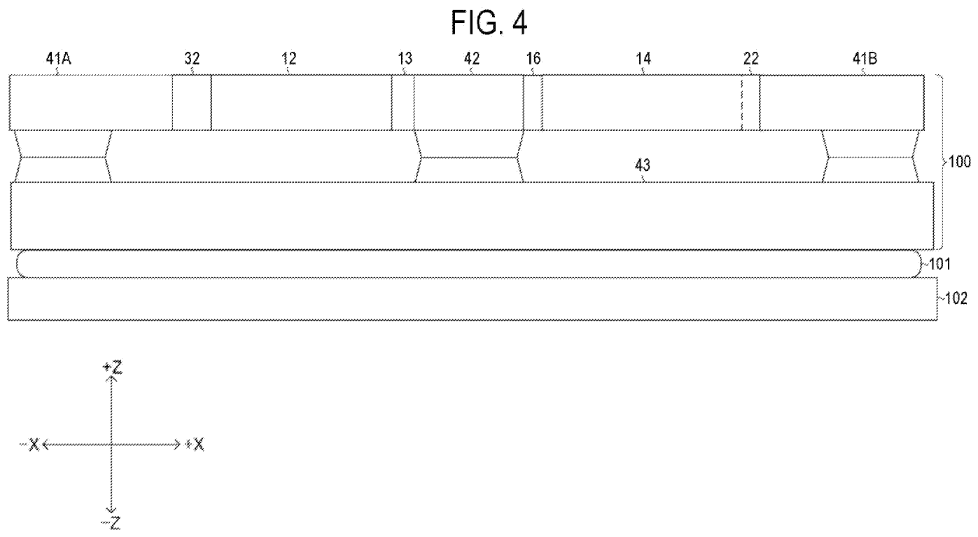

FIG. 3 is a plan view showing another structural example of the acceleration sensor 100. FIG. 4 is a side view showing another structural example of the acceleration sensor 100. FIG. 3 depicts only a portion of the acceleration sensor 100 on the +Z direction side.

In the structural example shown in FIGS. 1 and 2, the connection portions 21 and 22 are arranged along the Y-axis direction, while in the structural example shown in FIGS. 3 and 4, the connection portions 21 and 22 are arranged along the X-axis direction.

Further, in the structural example shown in FIGS. 3 and 4, the support portion 41A supports the flat plate portion 11, the flat plate portion 12, and the connection portion 21 via the elastic structure portions 31 and 32, and the support portion 41B supports the flat plate portion 14, the flat plate portion 15, and the connection portion 22 without interposing an elastic structure portion. In the structural example shown in FIGS. 3 and 4, the base portion 43 supports the support portions 41A, 41B, and 42.

In the structural example shown in FIGS. 1 and 2 and the structural example shown in FIGS. 3 and 4, the electrodes 1 and 2 are movable electrodes, and the electrode 3 provided between the electrodes 1 and 2 is a fixed electrode. However, the structure of the acceleration sensor 100 is not limited to these structural examples. The acceleration sensor 100 may have a structure in which the electrodes 1 and 2 are fixed electrodes, and the electrode 3 provided between the electrodes 1 and 2 is a movable electrode.

### First Embodiment

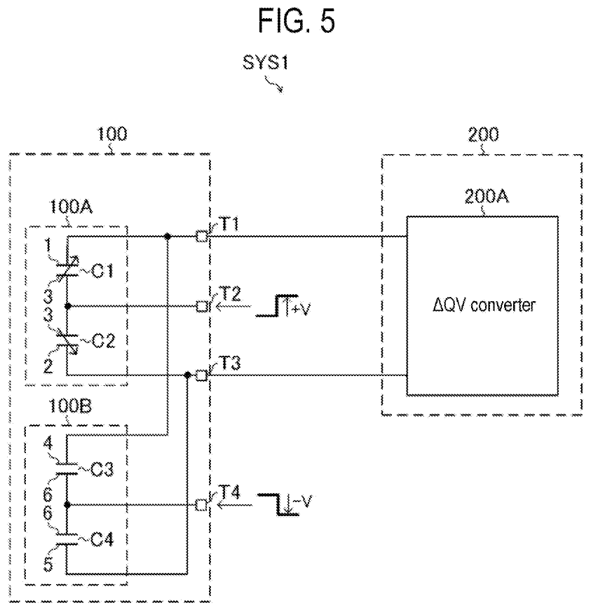

FIG. 5 is a diagram showing a schematic configuration of an acceleration sensor system according to a first embodiment. The acceleration sensor system SYS1 shown in FIG. 5 includes an acceleration sensor 100 and a processing part 200.

The acceleration sensor 100 includes an acceleration detection part 100A and an offset detection part 100B. The acceleration sensor 100 is a capacitive acceleration sensor. The acceleration detection part 100A detects acceleration in a predetermined direction (the Y-axis direction shown in FIGS. 1 and 3). The offset detection part 100B detects an offset amount with respect to the acceleration detection part 100A.

The acceleration detection part 100A includes electrodes 1 and 2 which are fixed electrodes, and an electrode 3 which is a movable electrode provided between the electrodes 1 and 2. A variable capacitor (capacitor whose electrostatic capacitance value is variable) C1 is formed between the electrodes 1 and 3, and a variable capacitor C2 is formed between the electrodes 2 and 3.

The offset detection part 100B includes electrodes 4 and 5 which are fixed electrodes, and an electrode 6 which is a fixed electrode provided between the electrodes 4 and 5. A fixed capacitor (capacitor whose capacitance value is fixed) C3 is formed between the electrodes 4 and 6, and a fixed capacitor C4 is formed between the electrodes 5 and 6.

The processing part 200 processes respective outputs of the acceleration detection part 100A and the offset detection part 100B. The processing part 200 is configured by, for example, an ASIC (Application Specific Integrated Circuit). The processing part 200 of the present embodiment includes a differential charge-to-voltage converter 200A.

The acceleration sensor 100 of the present embodiment further includes terminals T1 to T4. The terminal T1 is connected to the electrodes 1 and 4. The terminal T2 is connected to the electrode 3. The terminal T3 is connected to the electrodes 2 and 5. The terminal T3 is connected to the electrode 6.

Pulse voltages having opposite phases are applied to the terminals T1 and T4. As a result, a charge Q1 is generated at the electrode 1, and a charge Q2 having the same polarity as the charge Q1 is generated at the electrode 2. The charges Q1 and Q2 are represented by the following equations. The base capacitance Co[fF] is a capacitance that is structurally generated in each of the variable capacitors C1 and C2. The acceleration variable capacitance sensitivity Cs [fF/g] is a capacitance that is changed according to the acceleration in the Y-axis direction. Acceleration g is the acceleration in the Y-axis direction. The capacitance change coefficient Ct [fF/A° C.] is a coefficient related to the temperature change from a reference temperature. Although Ct is represented here as a first-order linear component of ΔT, the actual relationship is unknown. However, as in the following equations, it is considered that the capacitance changes due to the temperature changes are superimposed in the opposite directions in the variable capacitor C1 and the variable capacitor C2. The temperature change ΔT is a temperature change from a reference temperature.

Q1=(Co+Cs×g+Ct×ΔT)×V

Q2=(Co−Cs×g−Ct×ΔT)×V

Further, a charge Q1′ is generated at the electrode 4, and a charge Q2′ having the same polarity as the charge Q1′ is generated at the electrode 5. The charges Q1′ and Q2′ are represented by the following equations.

Q1′=−(Co+Ct×ΔT)×V

Q2′=(Co−Ct×ΔT)×V

Therefore, the charge Qout1 output from the terminal T1 and the charge Qout2 output from the terminal T3 are expressed by the following equations.

Qout1=Q1+Q1′=Cs×g×V

Qout2=Q2+Q2′=−Cs×g×V

The differential charge-to-voltage converter 200A receives the charge Qout1 from the terminal T1 and the charge Qout2 from the terminal T3. The differential charge-voltage converter 200A obtains a difference ΔQ between the charges Qout1 and Qout2, converts the difference ΔQ into a voltage, and outputs the voltage to the outside. The difference ΔQ is represented by the following equation.

ΔQ=Qout1−Qout2=2×Cs×g×V

The voltage outputted from the differential charge-to-voltage converter 200A to the outside is a voltage corresponding to the acceleration. The voltage outputted from the differential charge-to-voltage converter 200A to the outside has low temperature dependence (ideally zero). Therefore, the acceleration sensor system SYS1 can reduce detection errors caused by temperature changes.

Further, even when common mode noise is superimposed on the terminals T1 and T3, the common mode noise is removed by the difference due to the differential charge-to-voltage converter 200A.

Further, since the component of the base capacitance Co can be removed on the side of the acceleration sensor 100, it is possible to simplify the circuit configuration of the differential charge-to-voltage converter 200A.

### Second Embodiment

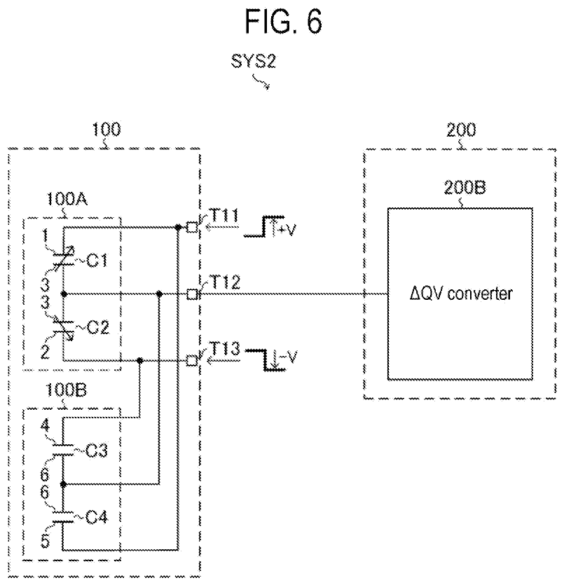

FIG. 6 is a diagram showing a schematic configuration of an acceleration sensor system according to a second embodiment. The acceleration sensor system SYS2 shown in FIG. 6 includes an acceleration sensor 100 and a processing part 200. In FIG. 6, the description of the same parts as in FIG. 5 will be omitted as appropriate.

The processing part 200 of the present embodiment includes a charge-to-voltage converter 200B.

The acceleration sensor 100 of the present embodiment further includes terminals T11 to T13. The terminal T11 is connected to the electrodes 1 and 5. The terminal T12 is connected to the electrodes 3 and 6. The terminal T13 is connected to the electrode 2. The terminal T3 is connected to the electrodes 2 and 4.

Pulse voltages having opposite phases are applied to the terminals T11 and T13. As a result, a charge Q1 is generated at the electrode 1, and a charge Q2 having the same polarity as the charge Q1 is generated at the electrode 2. The charges Q1 and Q2 are represented by the following equations.

Q1=(Co+Cs×g+Ct×ΔT)×V

Q2=(Co−Cs×g−Ct×ΔT)×V

Further, a charge Q1′ is generated at the electrode 4, and a charge Q2′ having the same polarity as the charge Q1′ is generated at the electrode 5. The charges Q1′ and Q2′ are represented by the following equations.

Q1′=−(Co+Ct×ΔT)×V

Q2′=(Co−Ct×ΔT)×V

Therefore, the charge Qout outputted from the terminal T12 is represented by the following equation.

Qout=Q1+Q2+Q1′+Q2′=2×Cs×g×V

The charge-to-voltage converter 200B receives the charge Qout from the terminal T12. The charge-to-voltage converter 200B converts the charge Qout into a voltage and outputs the voltage to the outside.

The voltage outputted from the charge-to-voltage converter 200B to the outside is a voltage corresponds to the acceleration. The voltage outputted from the charge-to-voltage converter 200B to the outside has low temperature dependence (ideally zero). Therefore, the acceleration sensor system SYS2 can reduce detection errors caused by temperature changes.

Further, the terminal specifications of the acceleration sensor 100 according to the present embodiment may be made common to the terminal specifications of the conventional acceleration sensor that does not include the offset detection part 100B. Therefore, the processing part 200 used in the acceleration sensor system SYS2 may have the same specifications as the processing part that processes the output of a conventional acceleration sensor that does not include the offset detection part 100B.

### Third Embodiment

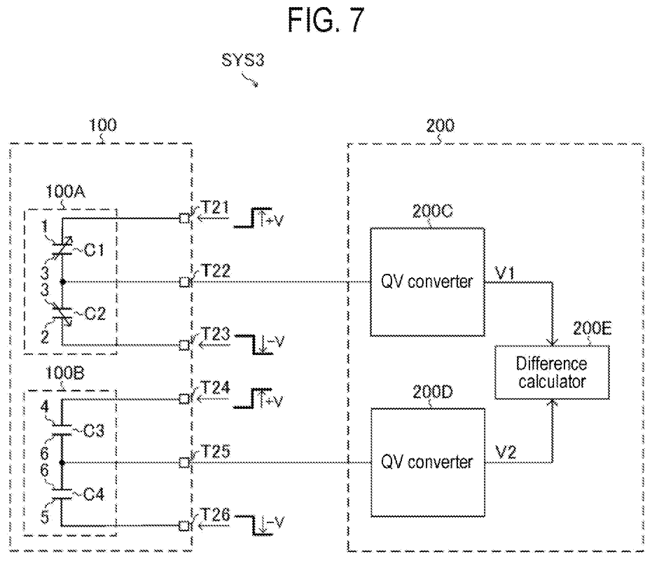

FIG. 7 is a diagram showing a schematic configuration of an acceleration sensor system according to a third embodiment. The acceleration sensor system SYS3 shown in FIG. 7 includes an acceleration sensor 100 and a processing part 200. In FIG. 7, the description of the same parts as in FIGS. 5 and 6 will be omitted as appropriate.

The processing part 200 of the present embodiment includes charge-to-voltage converters 200C and 200D and a difference calculator 200E.

The acceleration sensor 100 of the present embodiment further includes terminals T21 to T26. The terminal T21 is connected to the electrode 1. The terminal T22 is connected to the electrode 3. The terminal T23 is connected to the electrode 2. The terminal T24 is connected to the electrode 4. The terminal T25 is connected to the electrode 6. The terminal T26 is connected to the electrode 5.

Pulse voltages having opposite phases are applied to the terminals T21 and T23. As a result, a charge Q1 is generated at the electrode 3 of the variable capacitor C1, and a charge Q2 having a polarity opposite to that of the charge Q1 is generated at the electrode 3 of the variable capacitor C2. The charges Q1 and Q2 are represented by the following equations.

Q1=(Co+Cs×g+Ct×ΔT)×V

Q2=(Co−Cs×g−Ct×ΔT)×(−V)

Pulse voltages having opposite phases are applied to the terminals T24 and T26. As a result, a charge Q1′ is generated at the electrode 6 of the fixed capacitor C3, and a charge Q2′ having a polarity opposite to that of the charge Q1′ is generated at the electrode 6 of the fixed capacitor C4. The charges Q1′ and Q2′ are represented by the following equations.

Q1′=−(Co+Ct×ΔT)×V

Q2′=(Co−Ct×ΔT)×(−V)

Therefore, the charge Qout1 outputted from the terminal T22 and the charge Qout2 outputted from the terminal T24 are represented by the following equations.

Qout1=Q1+Q2=2×(Cs×g+Ct×ΔT)×V

Qout2=Q1′+Q2′=2×Ct×ΔT×V

The charge-to-voltage converter 200C receives the charge Qout1 from the terminal T22 and the charge Qout2 from the terminal T24. The charge-to-voltage converter 200C converts the charge Qout1 into a first voltage V1 and supplies the first voltage V1 to the difference calculator 200E. The charge-to-voltage converter 200D converts the charge Qout2 into a second voltage V2 and supplies the second voltage V2 to the difference calculator 200E. The difference calculator 200E calculates a difference between the first voltage V1 and the second voltage V2, and outputs a voltage, which is the calculation result, to the outside.

The voltage outputted from the difference calculator 200E to the outside is a voltage corresponds to the acceleration. The voltage outputted from the difference calculator 200E to the outside has low temperature dependence (ideally zero). Therefore, the acceleration sensor system SYS3 can reduce detection errors caused by temperature changes.

Further, even when common mode noise is superimposed on the terminals T22 and T24, the common mode noise is removed by the difference calculated by the difference calculator 200E.

### Fourth Embodiment

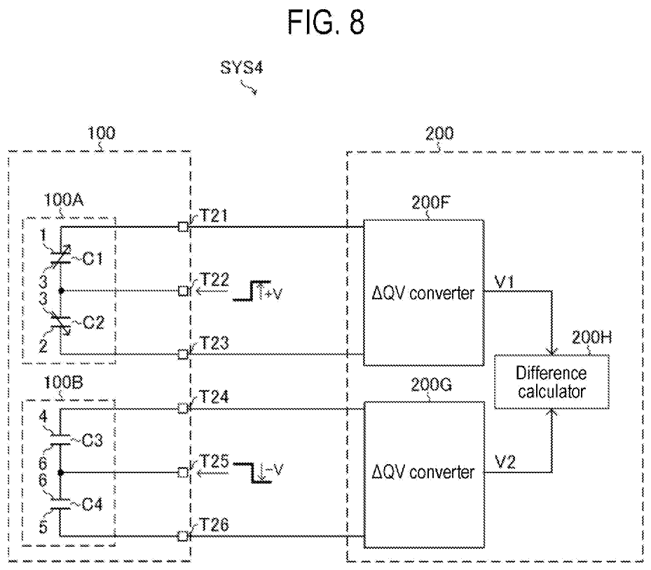

FIG. 8 is a diagram showing a schematic configuration of an acceleration sensor system according to a fourth embodiment. The acceleration sensor system SYS4 shown in FIG. 8 includes an acceleration sensor 100 and a processing part 200. In FIG. 8, the description of the same parts as in FIG. 7 will be omitted as appropriate.

The processing part 200 of the present embodiment includes differential charge-to-voltage converters 200F and 200G, and a difference calculator 200H.

Pulse voltages having opposite phases are applied to the terminals T22 and T25. As a result, a charge Q1 is generated at the electrode 1, and a charge Q2 having the same polarity as the charge Q1 is generated at the electrode 2. The charges Q1 and Q2 are represented by the following equations.

Q1=(Co+Cs×g+Ct×ΔT)×V

Q2=(Co−Cs×g−Ct×ΔT)×V

Further, a charge Q1′ is generated at the electrode 4, and a charge Q2′ having the same polarity as the charge Q1′ is generated at the electrode 5. The charges Q1′ and Q2′ are represented by the following equations.

Q1′=−(Co+Ct×ΔT)×V

Q2′=(Co−Ct×ΔT)×V

The charge Q1 is outputted from the terminal T21, and the charge Q2 is outputted from the terminal T23. The Charge Q1′ is outputted from the terminal T24, and the charge Q2′ is outputted from the terminal T26.

The differential charge-to-voltage converter 200F receives the charge Q1 from the terminal T21 and the charge Q2 from the terminal T23. The differential charge-to-voltage converter 200F obtains a difference ΔQ between the charge Q1 and the charge Q2, converts the difference ΔQ into a first voltage V1, and outputs the first voltage V1 to the difference calculator 200H.

The differential charge-to-voltage converter 200G receives the charge Q1′ from the terminal T24 and the charge Q2′ from the terminal T26. The differential charge-to-voltage converter 200G obtains a difference ΔQ′ between the charge Q1′ and the charge Q2′, converts the difference ΔQ′ into a second voltage V2, and outputs the second voltage V2 to the difference calculator 200H.

The difference calculator 200H calculates a difference between the first voltage V1 and the second voltage V2, and outputs the calculated voltage to the outside.

The voltage outputted from the difference calculator 200H to the outside is a voltage corresponds to the acceleration. The voltage outputted from the difference calculator 200H to the outside has low temperature dependence (ideally zero). Therefore, the acceleration sensor system SYS4 can reduce detection errors caused by temperature changes.

Further, even when common mode noise is superimposed on the terminals T21 and T23, the common mode noise is removed by the difference obtained by the differential charge-to-voltage converter 200F. Moreover, even when common mode noise is superimposed on the terminals T24 and T26, the common mode noise is removed by the difference obtained by the differential charge-to-voltage converter 200G.

<Trimming Process in the Processing Part>

In the third and fourth embodiments, it is necessary to perform the following trimming process in order to improve detection accuracy.

First, in a first trimming process, a setting that roughly cancels the component of the base capacitance Co is searched for at the front stage of the processing part 200 while the acceleration is kept zero. The charges that cannot be canceled at the front stage of the processing part 200 flow to a circuit of the next stage.

In a second trimming process following the first trimming process, the rest of the component of the base capacitance Co is canceled by automatic adjustment using a feedback control part provided in the processing part 200 while the acceleration is kept zero.

In a third trimming process following the second trimming process, a setting that cancels the difference between the capacitance of the variable capacitor C1 and the capacitance of the variable capacitor C2 is searched for at the next stage of the feedback control part of the processing part 200 while the acceleration is kept zero.

In the first and second embodiments described above, the acceleration sensor 100 cancels the component of the base capacitance Co and cancels the difference between the capacitance of the variable capacitor C1 and the capacitance of the variable capacitor C2. Therefore, in the acceleration sensor system SYS1 according to the first embodiment and the acceleration sensor system SYS2 according to the first embodiment described above, even if the circuits required for performing the first trimming process to the third trimming process are omitted or reduced, it is possible to reduce detection errors.

### <Others>

The embodiments of the present disclosure may be appropriately modified in various ways within the scope of the technical ideas indicated in the claims. The various embodiments described so far may be appropriately combined within a consistent range. The above embodiments are nothing more than examples of the embodiments of the present disclosure, and the meanings of the terms of respective elements of the present disclosure are not limited to those described in the above embodiments.

For example, although a single-axis acceleration sensor is used in each of the above-described embodiments, a multi-axis acceleration sensor may be used.

### <Supplementary Notes>

Supplementary notes are provided for the present disclosure for which specific configuration examples are shown in the above-described embodiments.

An acceleration sensor system (SYS1 to SYS3) of the present disclosure includes: an acceleration sensor (100) including an acceleration detection part (100A) configured to detect acceleration in a predetermined direction and an offset detection part (100B) configured to detect an offset amount with respect to the acceleration detection part; and a processing part (200) configured to process respective outputs of the acceleration detection part and the offset detection part, wherein the acceleration detection part includes a first electrode (1), a second electrode (2), and a third electrode (3) provided between the first electrode and the second electrode, wherein one of each of the first and second electrodes and the third electrode is a fixed electrode while the other of each of the first and second electrodes and the third electrode is a movable electrode, wherein a first variable capacitor (C1) is formed between the first electrode and the third electrode, wherein a second variable capacitor (C2) is formed between the second electrode and the third electrode, wherein the offset detection part includes a fourth electrode (4), a fifth electrode (5), and a sixth electrode (6) provided between the fourth electrode and the fifth electrode, wherein the fourth electrode, the fifth electrode, and the sixth electrode are fixed electrodes, wherein a first fixed capacitor (C3) is formed between the fourth electrode and the sixth electrode, and wherein a second fixed capacitor (C4) is formed between the fifth electrode and the sixth electrode (First Configuration).

The acceleration sensor system of the First Configuration, wherein a shape and a size of the first electrode are the same as a shape and a size of the second electrode, a shape and a size of the fourth electrode, and a shape and a size of the sixth electrode, respectively, and wherein a shape and a size of the third electrode are the same as the shape and the size of the sixth electrode (Second Configuration).

The acceleration sensor system of the First or Second Configuration, wherein the acceleration sensor further includes: a first terminal (T1) configured to be connected to the first electrode and the fourth electrode; a second terminal (T2) configured to be connected to the third electrode; a third terminal (T3) configured to be connected to the second electrode and the fifth electrode; and a fourth terminal (T4) configured to be connected to the sixth electrode (Third Configuration).

The acceleration sensor system of the Third Configuration, wherein the processing part is configured to generate a voltage corresponding to a difference between a charge outputted from the first terminal and a charge outputted from the third terminal (Fourth Configuration).

The acceleration sensor system of the First or Second Configuration, wherein the acceleration sensor further includes: a first terminal (T11) configured to be connected to the first electrode and the fifth electrode; a second terminal (T12) configured to be connected to the third electrode and the sixth electrode; and a third terminal (T13) configured to be connected to the second electrode and the fourth electrode (Fifth Configuration).

The acceleration sensor system of the Fifth Configuration, wherein the processing part is configured to generate a voltage corresponding to a charge outputted from the second terminal (Sixth Configuration).

The acceleration sensor system of the First or Second Configuration, wherein the acceleration sensor further includes: a first terminal (T21) configured to be connected to the first electrode; a second terminal (T22) configured to be connected to the third electrode; a third terminal (T23) configured to be connected to the second electrode; a fourth terminal (T24) configured to be connected to the fourth electrode; a fifth terminal (T25) configured to be connected to the sixth electrode; and a sixth terminal (T26) configured to be connected to the fifth electrode (Seventh Configuration).

The acceleration sensor system of the Seventh Configuration, wherein the processing part is configured to generate a first voltage corresponding to a charge outputted from the second terminal, generate a second voltage corresponding to a charge outputted from the fifth terminal, and obtain a difference between the first voltage and the second voltage (Eighth Configuration).

The acceleration sensor system of the Seventh Configuration, wherein the processing part is configured to generate a first voltage corresponding to a difference between a charge outputted from the first terminal and a charge outputted from the third terminal, generate a second voltage corresponding to a difference between the charge outputted from the third terminal and a charge outputted from the fourth terminal, and obtain a difference between the first voltage and the second voltage (Ninth Configuration).

According to the present disclosure in some embodiments, it is possible to reduce detection errors caused by temperature changes.

While certain embodiments have been described, these embodiments have been presented by way of example only, and are not intended to limit the scope of the disclosures. Indeed, the embodiments described herein may be embodied in a variety of other forms. Furthermore, various omissions, substitutions, and changes in the form of the embodiments described herein may be made without departing from the spirit of the disclosures. The accompanying claims and their equivalents are intended to cover such forms or modifications as would fall within the scope and spirit of the disclosures.

What is claimed is:

1. An acceleration sensor system, comprising:
an acceleration sensor including an acceleration detection part configured to detect acceleration in a predetermined direction and an offset detection part configured to detect an offset amount with respect to the acceleration detection part; and
a processing part configured to process respective outputs of the acceleration detection part and the offset detection part,
wherein the acceleration detection part includes a first electrode, a second electrode, and a third electrode provided between the first electrode and the second electrode,
wherein one of each of the first and second electrodes and the third electrode is a fixed electrode while the other of each of the first and second electrodes and the third electrode is a movable electrode,
wherein a first variable capacitor is formed between the first electrode and the third electrode,
wherein a second variable capacitor is formed between the second electrode and the third electrode,
wherein the offset detection part includes a fourth electrode, a fifth electrode, and a sixth electrode provided between the fourth electrode and the fifth electrode,
wherein the fourth electrode, the fifth electrode, and the sixth electrode are fixed electrodes,
wherein a first fixed capacitor is formed between the fourth electrode and the sixth electrode, and
wherein a second fixed capacitor is formed between the fifth electrode and the sixth electrode.

2. The system of claim 1, wherein a shape and a size of the first electrode are the same as a shape and a size of the second electrode, a shape and a size of the fourth electrode, and a shape and a size of the sixth electrode, respectively, and
wherein a shape and a size of the third electrode are the same as the shape and the size of the sixth electrode.

3. The system of claim 1, wherein the acceleration sensor further includes:
a first terminal configured to be connected to the first electrode and the fourth electrode;
a second terminal configured to be connected to the third electrode;
a third terminal configured to be connected to the second electrode and the fifth electrode; and
a fourth terminal configured to be connected to the sixth electrode.

4. The system of claim 3, wherein the processing part is configured to generate a voltage corresponding to a difference between a charge outputted from the first terminal and a charge outputted from the third terminal.

5. The system of claim 1, wherein the acceleration sensor further includes:
a first terminal configured to be connected to the first electrode and the fifth electrode;
a second terminal configured to be connected to the third electrode and the sixth electrode; and
a third terminal configured to be connected to the second electrode and the fourth electrode.

6. The system of claim 5, wherein the processing part is configured to generate a voltage corresponding to a charge outputted from the second terminal.

7. The system of claim 1, wherein the acceleration sensor further includes:
a first terminal configured to be connected to the first electrode;
a second terminal configured to be connected to the third electrode;
a third terminal configured to be connected to the second electrode;
a fourth terminal configured to be connected to the fourth electrode;
a fifth terminal configured to be connected to the sixth electrode; and
a sixth terminal configured to be connected to the fifth electrode.

8. The system of claim 7, wherein the processing part is configured to generate a first voltage corresponding to a charge outputted from the second terminal, generate a second voltage corresponding to a charge outputted from the fifth terminal, and obtain a difference between the first voltage and the second voltage.

9. The system of claim 7, wherein the processing part is configured to generate a first voltage corresponding to a difference between a charge outputted from the first terminal and a charge outputted from the third terminal, generate a second voltage corresponding to a difference between the charge outputted from the third terminal and a charge outputted from the fourth terminal, and obtain a difference between the first voltage and the second voltage.
